(19) United States
(12) Patent Application Publication
(10) Pub. No.: US 2020/0130081 A1
(43) Pub. Date: Apr. 30, 2020

(54) Reciprocating Filing Tool

(71) Applicant: Joe Kemp, Bryan, TX (US)

(72) Inventor: Joe Kemp, Bryan, TX (US)

(21) Appl. No.: 16/666,761

(22) Filed: Oct. 29, 2019

Related U.S. Application Data
(60) Provisional application No. 62/753,243, filed on Oct. 31, 2018.

(51) Int. Cl. B23D 71/02; B23D 71/08; B23D 67/04; B23D 67/12

(52) U.S. Cl. CPC B23D 71/02; B23D 71/08; B23D 63/162; B23D 67/12; B23D 67/04

(57) ABSTRACT

A reciprocating filing tool. The reciprocating filing tool includes a housing having a first end opposite a second end, wherein a handle is affixed to the second end. A shaft is slidably disposed within the housing, and a motor is operably connected to the shaft. The motor causes the shaft to move in a reciprocating linear movement when the motor is activated. A trigger disposed on the handle, wherein the trigger activates the motor when actuated. A plurality of files are removably securable to a distal end of the shaft. A plurality of clips are disposed on an exterior of the housing and can removably receive the plurality of files therein.

### CROSS REFERENCE TO RELATED APPLICATIONS

This application claims the benefit of U.S. Provisional Application No. 62/753,243 filed on Oct. 31, 2018. The above identified patent application is herein incorporated by reference in its entirety to provide continuity of disclosure.

### BACKGROUND OF THE INVENTION

The present invention relates to filing tools. More particularly, the present invention pertains to reciprocating filing tools having a plurality of interchangeable files.

Many individuals utilize tools with irregular shapes that must be maintained or otherwise sharpened, such as the chain of a chainsaw. Unfortunately, due to the intricate and irregular nature of chainsaw chains, many users must instead replace the chain when it becomes dull, which can be costly. Alternatively, manual filing may be an option, however such filing requires a great deal of time and effort to ensure that the entire chain is properly sharpened. This process can be time consuming and frustrating for the user. Traditional automatic sharpening options, such as grinders, while faster than manual filing, wear away excess material from the chain, forcing the user to replace each chain more frequently. Therefore, a device that can effectively sharpen irregular tools, such as chainsaw chains, without wearing away more material than necessary is desired.

In light of the devices disclosed in the known art, it is submitted that the present invention substantially diverges in design elements from the known art and consequently it is clear that there is a need in the art for an improvement to existing filing tools. In this regard, the instant invention substantially fulfills these needs.

### SUMMARY OF THE INVENTION

In view of the foregoing disadvantages inherent in the known types of filing tools now present in the known art, the present invention provides a filing tool wherein the same can be utilized for providing convenience for the user when filing irregularly shaped objects, such as the chain of a chainsaw.

The present system comprises a housing having a first end opposite a second end, wherein a handle is affixed to the second end. A shaft is slidably disposed within the housing. A motor is operably connected to the shaft, wherein the motor causes reciprocating linear movement of the shaft when activated. A trigger is disposed on the handle, wherein the trigger activates the motor when actuated. A plurality of files are removably securable to a distal end of the shaft. In some embodiments, a plurality of clips are affixed to an exterior of the housing, wherein the plurality of clips removably receive additional files of the plurality of files therein. In some embodiments, each file of the plurality of files is selected from a group consisting of a triangular file, a cylindrical file, a semi-cylindrical file, and a rectangular file. In alternate embodiments, a light source is disposed on the first end of the housing, such that the light source is configured to emit light towards a work surface. In yet another embodiment, a battery is removably securable to a proximal end of the handle, wherein the battery is operably connected to the motor when secured thereto.

In some embodiments, a chuck is disposed on the distal end of the shaft, wherein the chuck is configured to removably secure files of various diameters to the shaft. In another embodiment, each file of the plurality of files includes a connection member thereon wherein the connection member is configured to frictionally engage with an interior of the chuck when secured therein. This allows various files to be used interchangeably with the reciprocating filing tool.

In another embodiment, a variable control is disposed on the handle, wherein the variable control alters the rate of reciprocation generated by the motor when actuated, allowing a user to adjust the rate of filing for various tasks. In some embodiments, a stabilization platform extends from the first end, wherein the stabilization platform includes a cutout therein such that the file extends therethrough. The stabilization platform allows a user to brace the filing tool against the work surface to prevent the reciprocating motion from shifting the tool in an undesired direction. In some embodiments, the stabilization platform is arcuate, allowing a user to angle the file while braced against the work surface.

In some embodiments, the shaft is colinear with the handle, such that forces generated by the reciprocating motion of the shaft are transferred directly into the handle allowing a user to more readily control the tool without the aid of external bracing. In another embodiment, the shaft is offset from the handle, such that the user can provide increased leverage against the reciprocating movement of the shaft.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1A shows a perspective view of an embodiment of the reciprocating filing tool.

FIG. 1B shows a perspective view of an alternate embodiment of the reciprocating filing tool.

FIG. 2 shows a cross-sectional view of an embodiment of the reciprocating filing tool.

FIG. 3 shows a perspective view of the plurality of files of an embodiment of the reciprocating filing tool.

FIG. 4 shows an exploded view of an embodiment of the reciprocating filing tool.

### DETAILED DESCRIPTION OF THE INVENTION

Reference is made herein to the attached drawings. Like reference numerals are used throughout the drawings to depict like or similar elements of the reciprocating filing tool. The figures are intended for representative purposes only and should not be considered to be limiting in any respect.

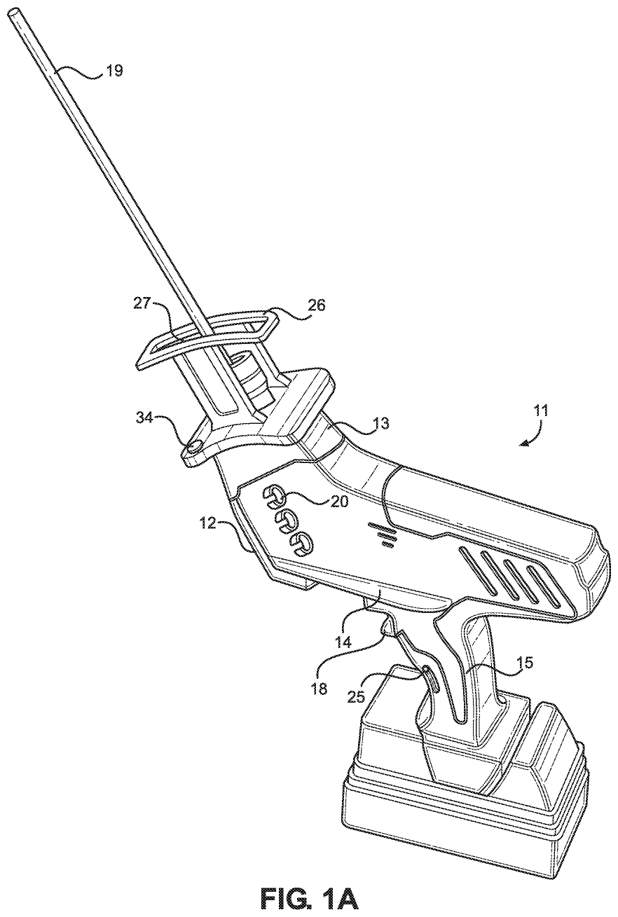

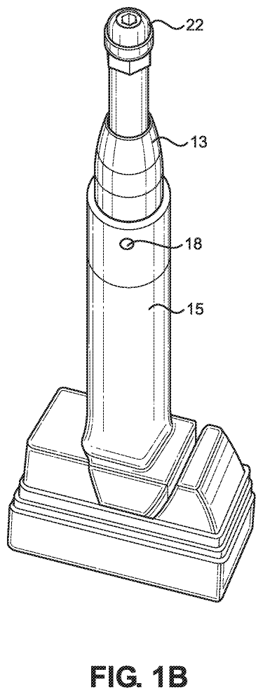

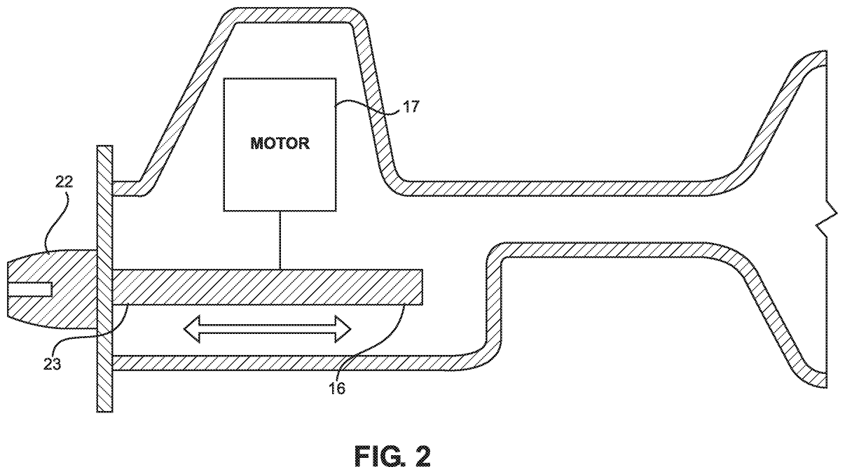

Referring now to FIGS. 1A and 1B, there are shown perspective views of various embodiments of the reciprocating filing tool. The reciprocating filing tool 11 comprises a housing 12 having a first end 13 opposite a second end 14, wherein a handle 15 extends from the second end 14. A shaft (as shown in FIG. 2, 16) is slidably disposed through the first end 13, wherein the shaft is configured to move in a reciprocating linear motion when the reciprocating filing tool 11 is in use. A file 19 is removably securable to the shaft in a coaxial relationship, such that the file 19 is driven in the same reciprocating linear motion of the shaft. In this way, the user can sharpen or otherwise file a desired surface within a confined space where traditional filing may be difficult to accomplish. Specifically, the present system can be readily used for sharpening irregular surfaces or shapes, such as the chain of a chainsaw. Additionally, in the shown embodiment, the housing 12 further comprises a plurality of vents disposed therethrough, the plurality of vents configured to provide ventilation to a motor (as shown in FIG. 2, 17) disposed within the housing 12, such that the motor is prevented from overheating.

In the shown embodiment of FIG. 1A, the housing 12 comprises an offset handle 15 not in linear alignment with the first end 13. In this embodiment, the user can provide additional leverage during use of the reciprocating filing tool 11 to brace against forces transferred through the housing 12 when the file 19 is in contact with a surface while the shaft is in motion. In the embodiment of FIG. 1B, the handle 15 is coaxially aligned with the shaft and the file 19. In this arrangement, the location of the file 19 can be more readily indexed, allowing a user to easily place the file 19 in a desired location. Additionally, the slimmer form factor of the embodiment of FIG. 1B allows the reciprocating filing tool 11 to be used and maneuvered in more confined spaces than the embodiment of FIG. 1A.

In the shown embodiments, a chuck 22 is disposed on the distal end of the shaft, wherein the chuck 22 is configured to removably secure a file 19 therein. The chuck 22 comprises an adjustable opening thereon, wherein rotation of the chuck 22 about the opening selectively increases or decreases the diameter of the opening. In this way, the reciprocating filing tool 11 can removably receive files 19 of various diameters therein. In the shown embodiment of FIG. 1B, the first end 13 of the housing 12 tapers radially inwardly relative to the longitudinal axis of the handle 15. In this way, the first end 13 can be inserted into and maneuvered within confined spaces.

As previously described above, the handle 15 can be alternatively coaxial with the shaft (as in FIG. 1B) or offset from the shaft (as in FIG. 1A), wherein each arrangement comprises additional advantages and disadvantages. In the illustrated embodiments, the handle 15 further comprises a trigger 18 disposed thereon. The trigger 18 is configured to initiate the reciprocating movement of the shaft when actuated. In some embodiments, the handle 15 further comprises a variable control 25 thereon, wherein the variable control 25 is configured to adjust the rate of reciprocation of the shaft. In this way, the user can accurately control the rate of reciprocation such that the targeted surface is properly sharpened with minimal material waste. In the illustrated embodiment, the variable control 25 comprises a knob, however, in alternate embodiments, the variable control 25 is associated with the trigger 18 such that the rate of reciprocation is relative to the depth of depression of the trigger 18. For example, should a user require greater rates of reciprocation, the trigger 18 can be depressed more to increase the rate of reciprocation.

In the illustrated embodiment of FIG. 1A, the housing 12 further comprises a stabilization platform 26 disposed on the first end 13 thereof. The stabilization platform 26 is configured to provide a surface upon which a user can brace the housing 12 during use. In the shown embodiment, the stabilization platform 26 is affixed to the first end 13 on opposing sides of the shaft. A cutout 27 is disposed through the stabilization platform 26 allowing the file 19 to extend therethrough. During use, the user can place the stabilization platform 26 flush against a desired work surface, allowing the user to bear down on the work surface through the stabilization platform 26 to counteract any forces transferred through the reciprocating filing tool 11 through reciprocation of the file 19.

In the shown embodiment of FIG. 1A, the housing 12 further comprises a plurality of clips 20 along a lateral side thereof. The plurality of clips 20 are configured to removable secure one or more files 19 therein, allowing a user to readily store additional files 19 with the reciprocating filing tool 11, In this way, the files 19 are additionally ready to be exchanged should a new file 19 be needed for the current filing task. In some embodiments, the plurality of clips 20 comprise C-shaped clamps configured to removably secure a file 19 therein via friction fit. In the shown embodiment, the plurality of clips 20 are aligned substantially parallel to the shaft, such that any files 19 stored therein extend substantially perpendicular to the shaft. In this way, the reciprocating motion of the shaft does not dislodge or otherwise remove any files 19 stored within the plurality of clips 20 during use. In alternate embodiments, the plurality of clips 20 are secured along alternate locations of the reciprocating filing tool 11, such as a base of the handle 15.

In the illustrated embodiment of FIG. 1A, the first end 13 further comprises a light source 34 thereon. The light source 34 is configured to emit light in a direction of the file 19, such that a work surface is properly illuminated. In some embodiments, the light source 34 is configured to illuminate when the trigger 18 is depressed, such that the light source 34 is activated at all times during the operation of the file 19, however, in alternate embodiments, the light source 34 is activated by a separate light control disposed on the housing 12. In this way, the user can readily use the reciprocating filing tool 11 in low-light conditions. In some embodiments, the light source 34 comprises a light emitting diode, however, alternate light sources 34 are also contemplated.

Referring now to FIG. 2, there is shown a cross-sectional view of an embodiment of the reciprocating filing tool. In the shown embodiment, the shaft 16 is operably connected to a motor 17, such that activation of the motor 17 causes reciprocating linear movement of the shaft 16 about a longitudinal axis of the shaft 16. The motor 17 and operably connections to the shaft 16 can comprise a variety of rotary to linear drive arrangements as known in the art, including, but not limited to, Scotch yoke drives, swash plate drives, captive cam or eccentric, barrel cam, or the like. In this way, the shaft 16 moves in a reciprocating linear motion such that a file affixed thereto moves colinearly with the shaft 16. In the illustrated embodiment, the shaft 16 further comprises a chuck 22 disposed on a distal end 23 thereof, such that a user can removably secure a file to the shaft 16 via the chuck 22.

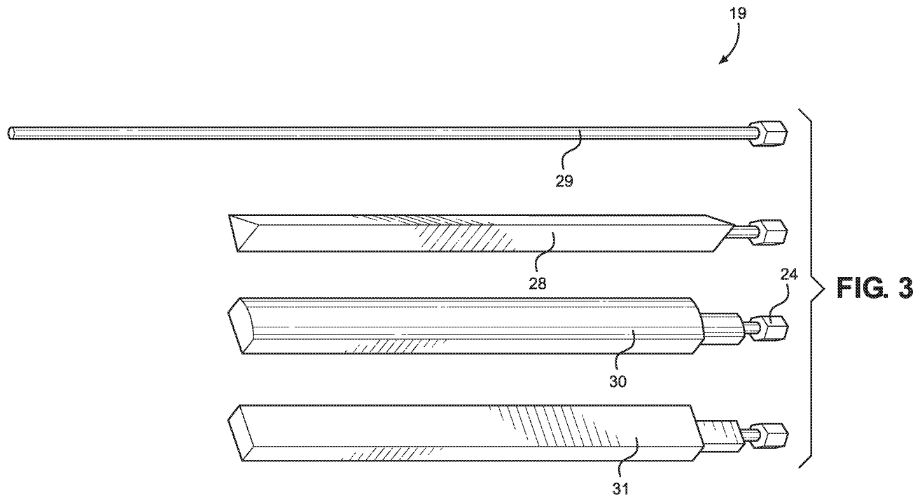

Referring now to FIG. 3, there is shown a perspective view of the plurality of files of an embodiment of the reciprocating filing tool. The plurality of files 19 can comprise a variety of shapes, styles, and types. In the shown embodiment, the plurality of files 19 includes a cylindrical file 29, a triangular file 28, a semi-cylindrical file 30, and a rectangular file 31. In this way, the user can exchange files 19 as needed to best suit the irregular surfaces of a desired filing target. In the illustrated embodiment, the cylindrical file 29 comprises a textured outer surface about an entirety of a length of the cylindrical file 29. Similarly, each lace of the triangular file 28 comprises a textured surface thereon. The semi-cylindrical file 30 comprises a planar surface opposite an arcuate surface, wherein each of the planar surface and arcuate surfaces are textured. In this way, the semi-cylindrical file 30 allows a user to file a surface requiring a cylindrical file 29 and a rectangular file 30 without first exchanging files 19 secured to the reciprocating filing tool. Finally, in the shown embodiment, a rectangular file 31 comprises a pair of planar surfaces disposed opposite each other, wherein each planar surface of the rectangular file 31 comprises a textured surface thereon.

In the shown embodiment, each of the plurality of files 19 further comprises a connection member 24 affixed to an end thereof, wherein the connection member 24 is configured to removably secure within the chuck. In some embodiments, the connection member 24 comprises a hexagonal cross-section, such that the connection member 24 can removably secure within a hex connection. Alternate connection member 24 cross-sections are contemplated to secure within various connection mechanisms known in the art. In the illustrated embodiment, each of the plurality of files 19 defines a neck between the connection member 24 and a body of the file 19, wherein the neck comprises a diameter less than that of each of the connection member 24 and the body. In such embodiments, the neck of the plurality of files 19 can secure within the plurality of clips disposed on the housing. In this way, the plurality of files 19 are prevented from sliding within the plurality of clips along a length thereof.

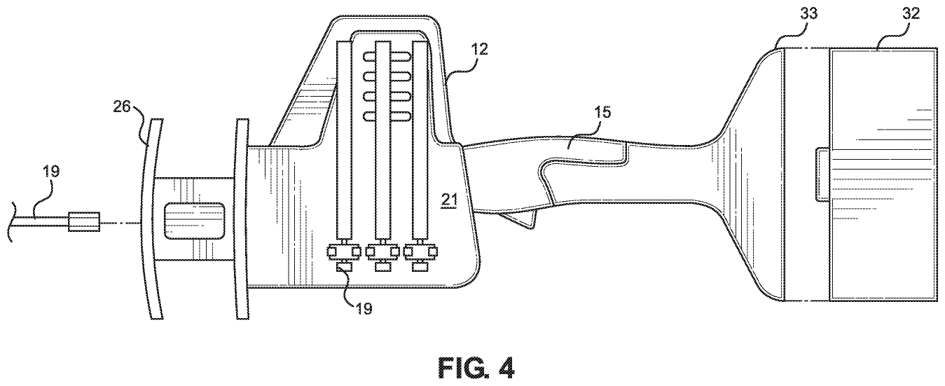

Referring now to FIG. 4, there is shown an exploded view of an embodiment of the reciprocating filing tool. In the illustrated embodiment, a battery 32 is removably securable to a proximal end 33 of the handle 15. The battery 32 is configured to operably connect to the motor when the battery 32 is removably secured to the proximal end 33. In this way, the battery 32 can be easily exchanged or recharged between uses of the reciprocating filing tool. In the shown embodiment, the proximal end 33 tapers radially outward from the handle 15 to match the cross-section of the battery 32. In this way, the battery 32 rests flush with the proximal end 33 to prevent accidental removal of the battery 32 during use. Additionally, the proximal end 33 serves to prevent the user's hand from sliding off the handle 15 when the reciprocating file tool is in use.

As previously discussed, the plurality of clips are disposed on an exterior surface 21 of the housing 12 and removably secure the plurality of files 19 therein. In the shown embodiment, the plurality of clips are oriented such that the plurality of files 19 extend along the housing 12 in a direction substantially perpendicular to that of the shaft, such that the reciprocating linear movement thereof does not dislodge the plurality of files 19 from the plurality of clips. In this way, the plurality of files are readily available to be exchanged should the user desire a different style or size of file 19.

Further, in the illustrated embodiment, the stabilization platform 26 comprises an arcuate shape, such that the reciprocating filing tool can be repositioned during use while still being braced against a support surface. In this way, the user can readily adjust the angle of incidence of the file 19 during use, so as to properly file each surface of an irregularly shaped object, while still providing proper stabilization and bracing.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A reciprocating filing tool, comprising:
a housing having a first end opposite a second end;
wherein a handle is affixed to the second end;
a shaft slidably disposed within the housing;
a motor operably connected to the shaft, wherein the motor causes eciprocating linear movement of the shaft when activated;
a trigger disposed on the handle wherein the trigger activates the motor when actuated;
a plurality of files removably securable to a distal end of the shaft;
a plurality of clips disposed on an exterior of the housing, wherein the plurality of clips removably receive the plurality of flies therein.

2. The reciprocating filing tool of claim 1, wherein a chuck is disposed on the distal end, wherein the chuck is configured to removably secure files of various diameters to the shaft.

3. The reciprocating filing tool of claim 2, wherein each file of the plurality of files further comprises a connection member configured to frictionally engage the chuck when secured therein.

4. The reciprocating filing tool of claim 1, further comprising a variable control disposed on the handle, wherein the variable control alters a rate of reciprocation generated by the motor when actuated.

5. The reciprocating filing tool of claim 1, wherein the handle and the shaft are colinear.

6. The reciprocating filing tool of claim 1, further comprising a stabilization platform extending from the first end, the stabilization platform having a cutout therein to receive the file therethrough.

7. The reciprocating filing tool of claim 6, wherein the stabilization platform is arcuate.

8. The reciprocating filing tool of claim 1, wherein a file of the plurality of files is selected from a group consisting of: a triangular file, a cylindrical file a semi-cylindrical file, and a rectangular file.

9. The reciprocating filing tool of claim 1, further comprising a battery removably securable to a proximal end of the handle, wherein the battery is operably connected to the motor when secured to the handle.

10. The reciprocating filing tool of claim 1, wherein the shaft is offset from the handle.

11. A reciprocating filing tool, comprising:
a housing having a first end opposite a second end;
wherein a handle is affixed to the second end;
a shaft slidably disposed within the housing;
a motor operably connected to the shaft, wherein the motor causes reciprocating linear movement of the shaft when activated;
a trigger disposed on the handle, wherein the trigger activates the motor when actuated;
a plurality of files removably securable to a distal end of the shaft;
a light source disposed on the first end of the housing, wherein the light source is positioned to emit light towards a work surface.

12. The reciprocating filing tool of claim 11, wherein a chuck is disposed on the distal end, wherein the chuck is configured to removably secure files of various diameters to the shaft.

13. The reciprocating filing tool of claim 12, wherein each file of the plurality of files further comprises a connection member configured to frictionally engage the chuck when secured therein.

14. The reciprocating filing tool of claim 11, further comprising a variable control disposed on the handle, wherein the variable control alters a rate of reciprocation generated by the motor when actuated.

15. The reciprocating filing tool of claim 11, wherein the handle and the shaft are colinear.

16. The reciprocating filing tool of claim 11, further comprising a stabilization platform extending from the first end, the stabilization platform having a cutout therein to receive the file therethrough.

17. The reciprocating filing tool of claim 16, wherein the stabilization platform is arcuate.

18. The reciprocating filing tool of claim 11, wherein a file of the plurality of files is selected from a group consisting of: a triangular file, a cylindrical file, a semi-cylindrical file, and a rectangular file.

19. The reciprocating filing tool of claim 11, further comprising a battery removably securable to a proximal end of the handle, wherein the battery is operably connected to the motor when secured to the handle.

20. The reciprocating filing tool of claim 11, wherein the shaft is offset from the handle.
